(19) United States
(12) Patent Application Publication
(10) Pub. No.: US 2013/0050899 A1
(43) Pub. Date: Feb. 28, 2013

(54) MULTILAYER CERAMIC CAPACITOR

(71) Applicants: Hyung Joon Kim, Suwon (KR); Byoung Hwa Lee, Seongnam (KR)

(72) Inventors: Hyung Joon Kim, Suwon (KR); Byoung Hwa Lee, Seongnam (KR)

(73) Assignee: SAMSUNG ELECTRO-MECHANICS CO., LTD.

(21) Appl. No.: 13/451,251

(22) Filed: Apr. 19, 2012

(30) Foreign Application Priority Data
Aug. 26, 2011 (KR) 10-2011-0085767

(51) Int. Cl. H01G 4/12

(52) U.S. Cl. 361/321.2

(57) ABSTRACT

There is provided a multilayer ceramic capacitor including: a ceramic body; first and second internal electrodes including respective lead-out portions having an overlapping area, the overlapping area being exposed to one surface of the ceramic body; first and second external electrodes formed on the one surface of the ceramic body and connected to the respective lead-out portions; and an insulation layer formed on the one surface of the ceramic body to which the lead-out portions are exposed.

### CROSS-REFERENCE TO RELATED APPLICATIONS

This application claims the priority of Korean Patent Application No. 10-2011-0085767 filed on Aug. 26, 2011, in the Korean Intellectual Property Office, the disclosure of which is incorporated herein by reference.

### BACKGROUND OF THE INVENTION

1. Field of the Invention

The present invention relates to a multilayer ceramic capacitor, and more particularly, to a multilayer ceramic capacitor having excellent capacitance and low equivalent series inductance (ESL).

2. Description of the Related Art

Generally, electronic components using a ceramic material, such as a capacitor, an inductor, a piezoelectric element, a varistor, or a thermistor, or the like, include a ceramic body made of a ceramic material, internal electrodes formed within the ceramic body, and external electrodes mounted on surfaces of the ceramic body so as to be connected to the internal electrodes.

Among ceramic electronic components, a multilayer ceramic capacitor (MLCC) includes a plurality of laminated dielectric layers, internal electrodes disposed to face each other, in which each pair of internal electrodes has one of the dielectric layers disposed therebetween, and external electrodes electrically connected to the internal electrodes.

The multilayer ceramic capacitor provides the advantages of compactness, high capacitance, and ease of mounting, so it is therefore used extensively in mobile communications devices such as notebook computers, personal digital assistances (PDAs), and cellular phones.

Recently, as electronic products have been miniaturized and have become multi-functionalized, chip components have also tended to have been miniaturized and multi-functionalized. Accordingly, there is a need to miniaturize the multilayer ceramic capacitor and increase the capacitance thereof.

In addition, the multilayer ceramic capacitor has been usefully used as a bypass capacitor disposed in a large scale integration (LSI) power supply circuit. The multilayer ceramic capacity needs to have the capability to effectively remove high frequency noise in order to serve as a bypass capacitor. This demand has been further increased in accordance with the trend toward electronic devices having high frequencies. The multilayer ceramic capacitor used as the bypass capacitor may be electrically connected to a mounting pad on a circuit board through soldering, and the mounting pad may be connected to other external circuits through wiring patterns on, or conductive vias in, the circuit board.

The multilayer ceramic capacitor has equivalent series resistance (ESR) and equivalent series inductance (ESL) components in addition to a capacitance component. These ESR and ESL components may hinder a function of the bypass capacitor. Particularly, ESL increases capacitor inductance at high frequencies to thereby hinder high frequency noise removal characteristics.

### SUMMARY OF THE INVENTION

An aspect of the present invention provides a multilayer ceramic capacitor having excellent capacitance and low equivalent series inductance (ESL).

According to an aspect of the present invention, there is provided a multilayer ceramic capacitor including: a ceramic body; first and second internal electrodes including respective lead-out portions having an overlapping area, the overlapping area being exposed to one surface of the ceramic body; first and second external electrodes formed on the one surface of the ceramic body and connected to the respective lead-out portions; and an insulation layer formed on the one surface of the ceramic body.

The lead-out portions of the first and second internal electrodes may be exposed to the same surface of the ceramic body.

The first and second internal electrodes may be disposed perpendicularly to a mounting surface of the ceramic body.

The first external electrode may be connected to a portion of the lead-out portion of the first internal electrode that does not overlap the lead-out portion of the second internal electrode.

The insulation layer may be formed by applying a ceramic slurry to the ceramic body.

The insulation layer may entirely cover the overlapping area of the lead-out portions of the first and second internal electrodes.

The insulation layer may have a height lower than those of the first and second external electrodes measured from the one surface of the ceramic body.

The ceramic body may have a shorter length in an x-direction, in which the first and second external electrodes, having a predetermined interval therebetween, are formed, than that of a y-direction, in which the first and second internal electrodes are laminated.

The first internal electrode may have at least two lead-out portions, and the at least two lead-out portions of the first internal electrode may form overlapping areas with the lead-out portion of the second internal electrode.

The first internal electrode may have at least two lead-out portions exposed to the same surface of the ceramic body, and the at least two lead-out portions of the first internal electrode may form overlapping areas with the lead-out portion of the second internal electrode.

The multilayer ceramic capacitor may further include a third external electrode connected to a respective lead-out portion of the first internal electrode, wherein the first internal electrode may have two lead-out portions, and the two lead-out portions of the first internal electrode may form overlapping areas with the lead-out portion of the second internal electrode.

The first and second internal electrodes may have two respective lead-out portions exposed to the one surface of the ceramic body and the other surface opposed thereto, and the two lead-out portions of the first internal electrode may form overlapping areas with the two lead-out portions of the second internal electrode.

The multilayer ceramic capacitor may further include third and fourth external electrodes connected to respective lead-out portions of the first and second internal electrodes, wherein the first and second internal electrodes may have two respective lead-out portions exposed to the one surface of the ceramic body and the other surface opposed thereto, and the two lead-out portions of the first internal electrode may form overlapping areas with the two lead-out portions of the second internal electrode.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1A and 1B are schematic perspective views showing a multilayer ceramic capacitor according to an embodiment of the present invention;

FIGS. 2 and 3 are, respectively, cross-sectional views showing a structure of internal electrodes of the multilayer ceramic capacitor shown in FIGS. 1A and 1B and cross-sectional views taken along line A-A′ of FIGS. 1A and 1B;

FIG. 4 is a cross-sectional view showing a multilayer ceramic capacitor according to another embodiment of the present invention;

FIG. 5 is a schematic perspective view showing a multilayer ceramic capacitor according to another embodiment of the present invention;

FIGS. 6 and 7 are, respectively, a cross-sectional view showing a structure of internal electrodes of the multilayer ceramic capacitor shown in FIG. 5 and a cross-sectional view of the multilayer ceramic capacitor shown in FIG. 5;

FIG. 8 is a schematic perspective view showing a multilayer ceramic capacitor according to another embodiment of the present invention;

FIGS. 9 and 10 are, respectively, a cross-sectional view showing a structure of internal electrodes of the multilayer ceramic capacitor shown in FIG. 8 and a cross-sectional view of the multilayer ceramic capacitor shown in FIG. 8;

FIG. 11 is a schematic perspective view showing a multilayer ceramic capacitor according to another embodiment of the present invention; and

FIGS. 12 and 13 are, respectively, a cross-sectional view showing a structure of internal electrodes of the multilayer ceramic capacitor shown in FIG. 11 and a cross-sectional view of the multilayer ceramic capacitor shown in FIG. 11.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like elements.

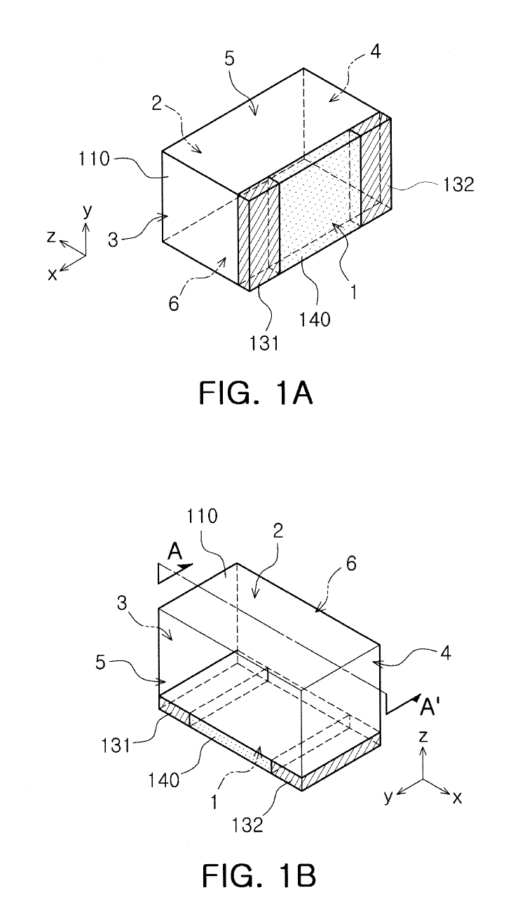

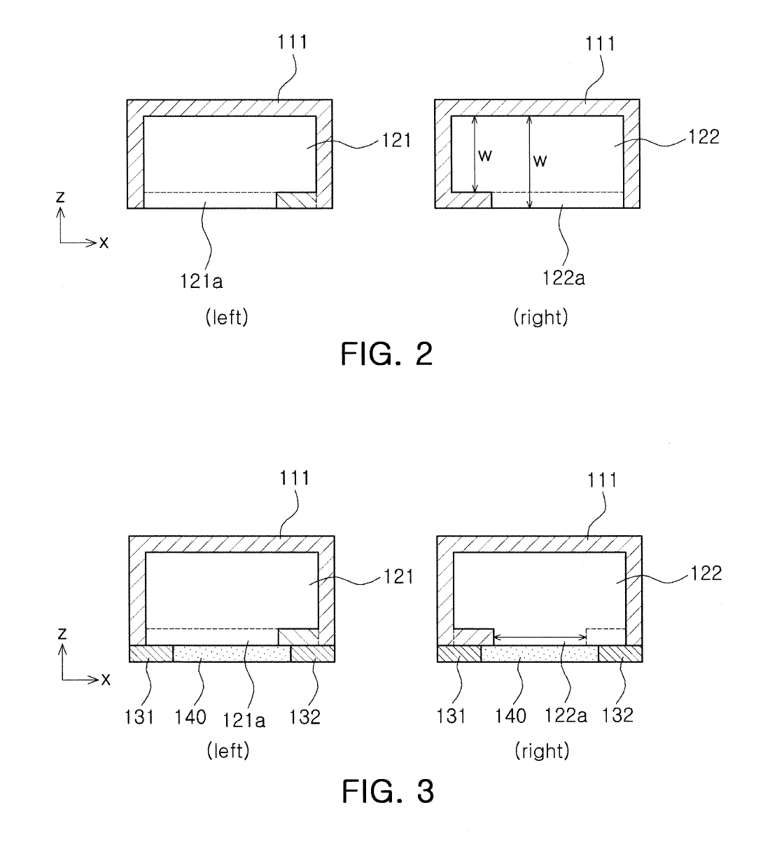

FIGS. 1A and 1B are schematic perspective views showing a multilayer ceramic capacitor according to an embodiment of the present invention. FIG. 2 is cross-sectional views showing a structure of internal electrodes of the multilayer ceramic capacitor shown in FIGS. 1A and 1B. FIG. 3 is cross-sectional views taken along line A-A′ of FIGS. 1A and 1B.

The multilayer ceramic capacitor according to the present embodiment may be a two-terminal vertically laminated or vertical multilayer capacitor. Here,“vertically laminated or vertical multilayer capacitor” means that internal electrodes laminated within a capacitor are disposed perpendicularly to a mounting surface of a circuit board, and “two-terminal” means that two terminals are connected to the circuit board as the capacitor terminals.

Referring to FIGS. 1A through 3, the multilayer ceramic capacitor according to the present embodiment may include a ceramic body 110; internal electrodes 121 and 122 formed within the ceramic body; and an insulation layer 140 and external electrodes 131 and 132 formed on one surface of the ceramic body.

According to the present embodiment, the ceramic body 110 may have first and second surfaces 1 and 2 opposing each other, and third to sixth surfaces 3 to 6 connecting the first and second surfaces 1 and 2 to each other. The shape of the ceramic body 110 is not particularly limited but may be a rectangular parallelepiped having the first to sixth surfaces, as shown. According to the embodiment of the present invention, the first surface 1 of the ceramic body may be amounting surface disposed on a mounting area of a circuit board.

According to the embodiment of the present invention, an x-direction refers to a direction in which first and second external electrodes, having a predetermined interval therebetween, are formed; a y-direction refers to a direction in which the internal electrodes, having dielectric layers therebetween, are laminated; and a z-direction refers to a direction in which the internal electrodes are mounted on the circuit board.

According to the embodiment of the present invention, the ceramic body 110 may be formed by laminating a plurality of dielectric layers 111. The plurality of dielectric layers 111 configuring the ceramic body 110 may be in a sintered state and may be integrated such that boundaries therebetween may not be readily apparent.

The dielectric layer 111 may be formed by firing a ceramic green sheet containing a ceramic powder, an organic solvent, and an organic binder. Here, the ceramic powder may have a high dielectric constant, and a barium titanate (BaTiO₃) based material, a strontium titanate (SrTiO₃) based material, or the like, maybe used therefor. However, the ceramic powder is not limited thereto.

According to the embodiment of the present invention, the ceramic body 110 may include the internal electrodes formed therein. FIG. 2 is a cross-sectional view showing the dielectric layer 111 configuring the ceramic body 110 and the internal electrodes 121 and 122 formed on the dielectric layer. According to the embodiment of the present invention, the first internal electrode 121 having a first polarity and the second internal electrode 122 having a second polarity may be formed as pairs and be disposed to face each other in the y-direction, having the dielectric layer 111 interposed therebetween. According to the embodiment of the present invention, the first and second internal electrodes 121 and 122 may be disposed perpendicularly to the mounting surface, that is, the first surface 1, of the multilayer ceramic capacitor.

In the embodiments of the present invention, first and second electrodes may have different polarities, first and third electrodes may have the same polarity, and second and fourth electrodes may have the same polarity.

According to the embodiment of the present invention, the first and second internal electrodes may be made of a conductive paste containing a conductive metal. The conductive metal may be Ni, Cu, Pd, or an alloy thereof but is not limited thereto.

The internal electrode maybe printed on a ceramic green sheet configuring the dielectric layer using a conductive paste through a printing method such as a screen printing method or a gravure printing method. The ceramic green sheets having the internal electrodes printed thereon may be alternately laminated and fired to thereby form the ceramic body.

Referring to FIG. 2, the first and second internal electrodes 121 and 122 have respective first and second lead-out portions 121a and 122a so as to be connected to the external electrodes having different polarities. The first and second lead-out portions 121a and 122a may be exposed to the first surface of the ceramic body. The multilayer ceramic capacitor according to the embodiment of the present invention may be a vertically laminated or vertical multilayer capacitor, the first and second lead-out portions 121a and 122a maybe exposed to the same surface of the ceramic body.

According to the embodiment of the present invention, the lead-out portion of the internal electrode is an area in which a conductor pattern forming the internal electrode has an increased width W to thereby be exposed to one surface of the ceramic body.

Generally, the first and second internal electrodes form capacitance in an overlapping area, and the lead-out portions connected to the external electrodes having different polarities do not have an overlapping area. However, according to the embodiment of the present invention, the first and second lead-out portions 121a and 122a may have an overlapping area. According to the embodiment of the present invention, the first and second lead-out portions are exposed to the first surface, and the exposed areas may be partially overlapped.

Referring to FIG. 3, the first external electrode 131 maybe formed to be connected to the first lead-out portion 121a of the first internal electrode exposed to the first surface of the ceramic body, and the second external electrode 132 may be formed to be connected to the second lead-out portion 122a of the second internal electrode exposed to the first surface of the ceramic body.

The first external electrode 131 may be connected to a portion of the first lead-out portion 121a that does not overlap the second lead-out portion 122a, and the second external electrode 132 may be connected to a portion of the second lead-out portion 122a that does not overlap the first lead-out portion 121a.

The first external electrode 131 may be connected to the portion of the first lead-out portion 121a so as not to contact the second lead-out portion 122a, and the second external electrode 132 may be connected to the portion of the second lead-out portion 122a so as not to contact the first lead-out portion 121a.

In the right view of FIG. 3, an overlapping area between the lead-out portion of the first internal electrode and the lead-out portion 122a of the second internal electrode is denoted by an arrow, and the first internal electrode 121 overlapping the second internal electrode 122 is denoted by a dotted line.

According to the embodiment of the present invention, the first and second lead-out portions 121a and 122a may have the overlapping area, and be connected to the first and second external electrodes 131 and 132 having different polarities, respectively.

According to the embodiment of the present invention, the first and second external electrodes 131 and 132 may be formed up to an edge formed by the first and third surfaces of the ceramic body and an edge formed by the first and fourth surfaces thereof, respectively.

According to the embodiment of the present invention, the insulation layer 140 may be formed on the first surface of the ceramic body. The insulation layer 140 may be formed between the first and second external electrodes 131 and 132. When being formed to cover the first and second lead-out portions 121a and 122a exposed to the first surface, the insulation layer 140 may entirely cover the overlapping area between the first and second lead-out portions.

The insulation layer 140 may be formed to completely cover one surface of the ceramic body between the first and second external electrodes.

In addition, although not shown, according to the embodiment of the present invention, the insulation layer may only cover the overlapping area between the first and second lead-out portions while having predetermined intervals from the first and second external electrodes 131 and 132.

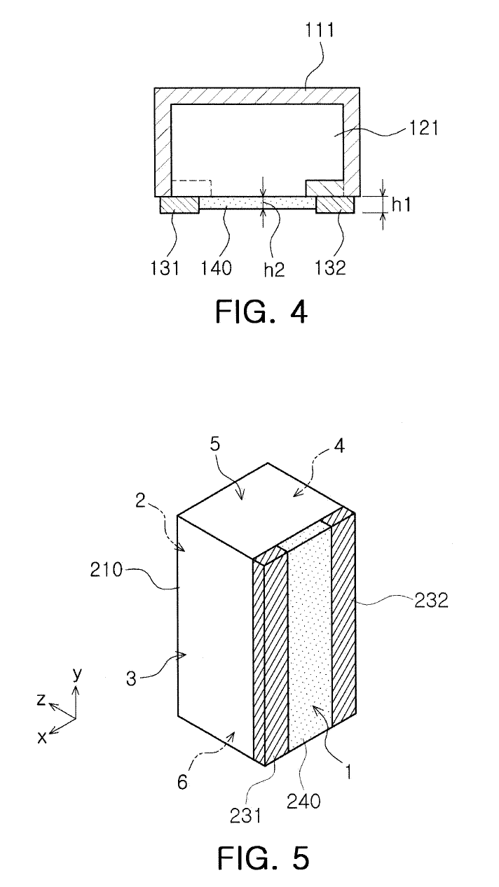

FIG. 4 is a cross-sectional view showing a multilayer ceramic capacitor according to another embodiment of the present invention. Hereinafter, components different from those of the above-mentioned embodiments may mainly be described and detailed descriptions of the same components will be omitted.

Referring to FIG. 4, first and second external electrodes 131 and 132 may be formed on a first surface of a ceramic body and an insulation layer 140 may be formed therebetween, similar to FIG. 3.

According to the present embodiment, the insulation layer 140 may have a height h2, lower than a height h1 of the first external electrode 131 or the second external electrode 132. The heights of the insulation layer and the external electrode maybe measured based on a mounting surface, that is, the first surface.

According to the present embodiment, the height of the insulation layer is lower than that of the first and second external electrodes, such that the multilayer ceramic capacitor may be more stably mounted on a circuit board.

In addition, the first and second external electrodes 131 and 132 may be formed on portions of the first surface of the ceramic body. The first and second external electrodes 131 and 132 may not be extended up to an edge formed by the first and third surfaces of the ceramic body or an edge formed by the first and fourth surfaces thereof.

According to the embodiment of the present invention, the insulation layer 140 may be made of a ceramic slurry. A position and a height of the insulation layer may be adjusted with reference to an amount and a shape of the ceramic slurry. The insulation layer 140 may be formed by applying a ceramic slurry to the ceramic body formed by a firing process and then firing the ceramic slurry.

Alternatively, the insulation layer 140 may be formed by forming a ceramic slurry for the insulation layer on the ceramic green sheet configuring the ceramic body and then firing the ceramic slurry together with the ceramic green sheet.

A method of forming the ceramic slurry is not particularly limited. For example, the ceramic slurry may be sprayed by a spray method or may be applied using a roller.

The insulation layer 140 covers the lead-out portions 121a and 122b of the first and second internal electrodes exposed to one surface of the ceramic body, whereby a short-circuit between the internal electrodes maybe prevented and an internal defect such as a deterioration in humidity resistance characteristics, or the like, may be prevented.

According to the embodiment of the present invention, since even the lead-out portions of the first and second internal electrodes are overapped, capacitance of the multilayer ceramic capacitor may be increased. In addition, a distance between the first and second internal electrodes to which external polarities are applied may be relatively close, such that a current loop may be shortened. Therefore, equivalent series inductance (ESL) may be reduced.

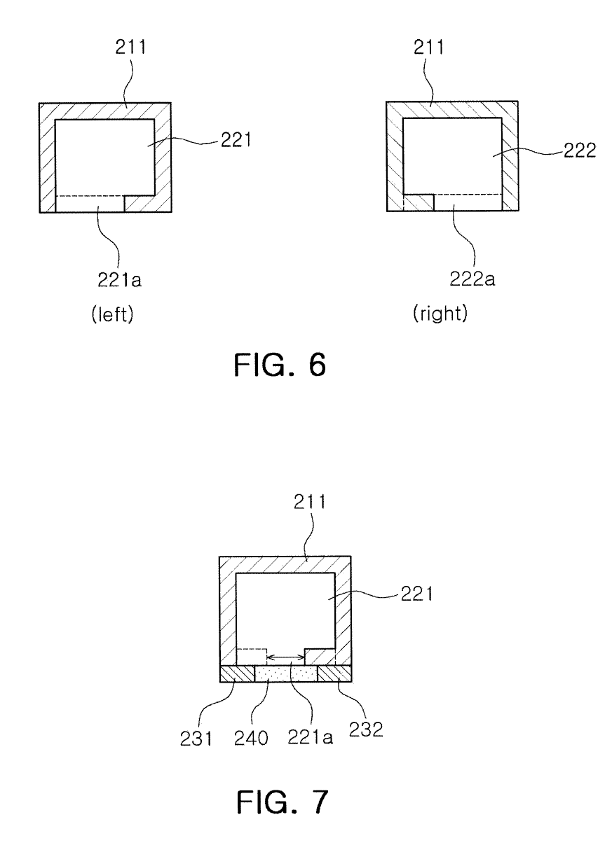

FIGS. 5 through 7 show a multilayer ceramic capacitor according to another embodiment of the present invention. FIG. 5 is a schematic perspective view showing the multilayer ceramic capacitor according to the present embodiment; FIG. 6 is a cross-sectional view showing a structure of internal electrodes of the multilayer ceramic capacitor shown in FIG. 5; and FIG. 7 is a cross-sectional view of the multilayer ceramic capacitor shown in FIG. 5. Hereinafter, components different from those of the above-mentioned embodiments may mainly be described and detailed descriptions of the same components will be omitted.

Referring to FIGS. 5 through 7, the multilayer ceramic capacitor according to the present embodiment may be a two-terminal vertically laminated or vertical multilayer capacitor. The multilayer ceramic capacitor according to the present embodiment may include a ceramic body 210; internal electrodes 221 and 222 formed within the ceramic body; and an insulation layer 240 and external electrodes 231 and 232 formed on one surface of the ceramic body.

According to the embodiment of the present invention, an x-direction refers to a direction in which the first and second external electrodes, having a predetermined interval therebetween, are formed; a y-direction refers to a direction in which the internal electrodes, having dielectric layers interposed therebetween, are laminated; and a z-direction refers to a direction in which the internal electrodes are mounted on the circuit board.

According to the present embodiment, the multilayer ceramic capacitor may have a shorter length in the x-direction than in the y-direction. That is, the length of the ceramic body in the x-direction, in which the first and second external electrodes, having a predetermined interval therebetween, are formed, may be shorter than the length thereof in the y-direction in which the internal electrodes are laminated.

FIG. 6 is a cross-sectional view showing a dielectric layer 211 configuring the ceramic body 210 and the internal electrodes 221 and 222 formed on the dielectric layer. According to the embodiment of the present invention, the first internal electrode 221 having a first polarity and the second internal electrode 222 having a second polarity may be formed as pairs and be disposed to face each other in the y-direction, having the dielectric layer 211 interposed therebetween. According to the embodiment of the present invention, the first and second internal electrodes 221 and 222 may be disposed perpendicularly to the mounting surface, that is, the first surface 1, of the multilayer ceramic capacitor.

Referring to FIG. 6, the first and second internal electrodes 221 and 222 have respective first and second lead-out portions 221a and 222a so as to be connected to the external electrodes having different polarities. The first and second lead-out portions 221a and 222a may be exposed to the first surface 1 of the ceramic body.

According to the embodiment of the present invention, the first and second lead-out portions 221a and 222a may have an overlapping area. According to the embodiment of the present invention, the first and second lead-out portions are exposed to the first surface, and the exposed areas may be partially overlapped.

Referring to FIG. 7, the first external electrode 231 maybe formed to be connected to the first lead-out portion 221a of the first internal electrode exposed to the first surface of the ceramic body, and the second external electrode 232 may be formed to be connected to the second lead-out portion 222a of the second internal electrode exposed to the first surface of the ceramic body.

The first external electrode 231 may be connected to a portion of the first lead-out portion 221a that does not overlap the second lead-out portion 222a, and the second external electrode 232 may be connected to a portion of the second lead-out portion 222a that does not overlap the first lead-out portion 221a.

In FIG. 7, an overlapping area between the lead-out portion 221a of the first internal electrode and the lead-out portion of the second internal electrode is denoted by an arrow, and the lead-out portion of the first internal electrode that does not overlap the lead-out portion of the second internal electrode is denoted by a dotted line.

According to the present embodiment, the insulation layer 240 maybe formed on the first surface of the ceramic body. The insulation layer 240 may be formed between the first and second external electrodes 231 and 232. When being formed to cover the first and second lead-out portions 221a and 222a exposed to the first surface, the insulation layer 240 may entirely cover the overlapping area between the first and second lead-out portions.

The insulation layer 240 covers the lead-out portions 221a and 222a of the first and second internal electrodes exposed to one surface of the ceramic body, whereby a short-circuit between the internal electrodes maybe prevented and an internal defect such as a deterioration in humidity resistance characteristics, or the like, may be prevented.

According to the present embodiment, since even the lead-out portions of the first and second internal electrodes are overapped, capacitance of the multilayer ceramic capacitor may be increased. In addition, a distance between the first and second internal electrodes to which external polarities are applied may be relatively close, such that a current loop may be shortened. Therefore, equivalent series inductance (ESL) may be reduced.

According to the embodiment of the present invention, the length of the multilayer ceramic capacitor in the x-direction is shorter than the length thereof in the y-direction, such that a distance between the first and second external electrodes may be shortened and a distance between the first and second internal electrodes to which external polarities are applied may be relatively close. Therefore, a current loop may be shortened and ESL may be further reduced.

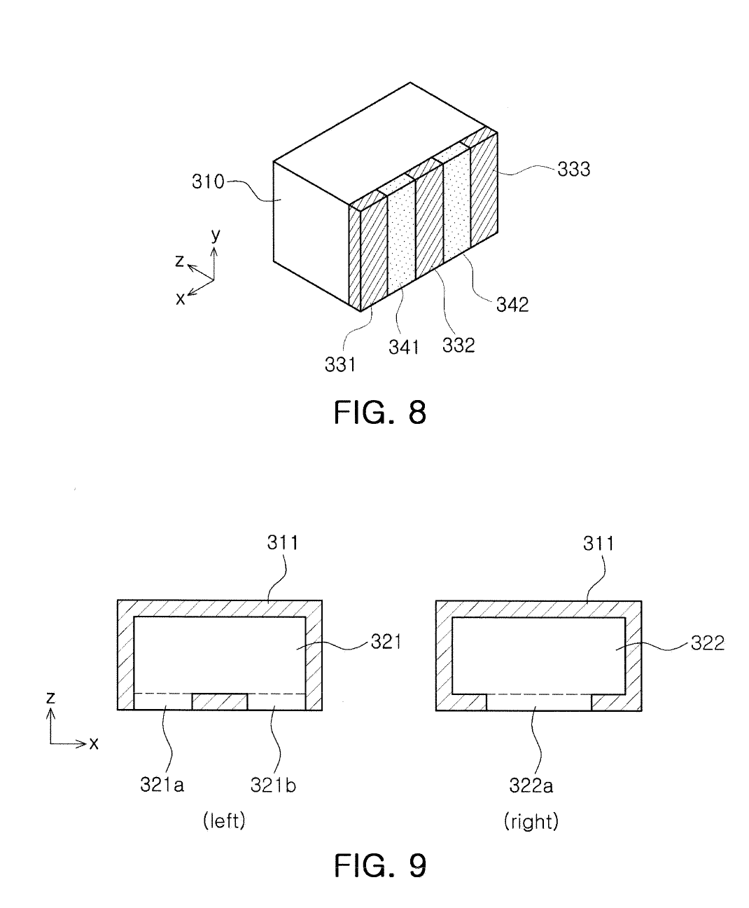

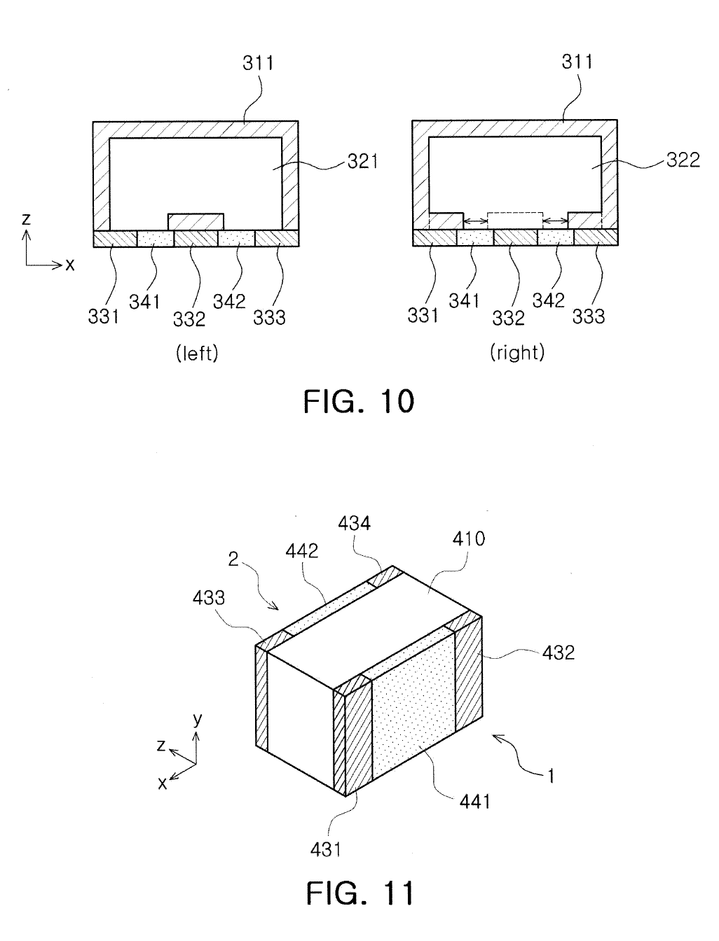

FIGS. 8 through 10 show a multilayer ceramic capacitor according to another embodiment of the present invention. FIG. 8 is a schematic perspective view showing the multilayer ceramic capacitor according to the present embodiment; FIG. 9 is a cross-sectional view showing a structure of internal electrodes of the multilayer ceramic capacitor shown in FIG. 8; and FIG. 10 is a cross-sectional view of the multilayer ceramic capacitor shown in FIG. 8. Hereinafter, components different from those of the above-mentioned embodiments may mainly be described and detailed descriptions of the same components will be omitted.

Referring to FIGS. 8 through 10, the multilayer ceramic capacitor according to the present embodiment may be a three-terminal vertically laminated or vertical multilayer capacitor. Here, “three-terminal” means that three terminals are connected to a circuit board as the capacitor terminals.

The multilayer ceramic capacitor according to the present embodiment may include a ceramic body 310; internal electrodes 321 and 322 formed within the ceramic body; and insulation layers 341 and 342 and external electrodes 331, 332, and 333 formed on one surface of the ceramic body.

FIG. 9 is a cross-sectional view showing a dielectric layer 311 configuring the ceramic body 310 and the internal electrodes 321 and 322 formed on the dielectric layer.

According to the embodiment of the present invention, the first internal electrode 321 having a first polarity and the second internal electrode 322 having a second polarity may be formed as a pair and be disposed to face each other in the y-direction, having the dielectric layer 311 interposed therebetween. According to the embodiment of the present invention, the first and second internal electrodes 321 and 322 may be disposed perpendicularly to the mounting surface of the multilayer ceramic capacitor.

Referring to FIG. 9, the first and second internal electrodes 321 and 322 have respective first and second lead-out portions 321a, 321b, and 322a so as to be connected to the external electrodes having different polarities. The first and second lead-out portions 321a, 321b, and 322a may be exposed to one surface of the ceramic body.

According to the present embodiment, the first internal electrode may have the two first lead-out portions 321a and 321b. Each of the two first lead-out portions 321a and 321b of the first internal electrode may have an area overlapping the second lead-out portion 322a of the second internal electrode. According to the embodiment of the present invention, the two first lead-out portions 321a and 321b of the first internal electrode and the second lead-out portion 322a of the second internal electrode may be exposed to the same surface of the ceramic body, and the exposed areas may be partially overlapped.

Referring to FIG. 10, the first and third external electrodes 331 and 333 may be formed on one surface of the ceramic body so as to be connected to the two first lead-out portions 321a and 321b of the first internal electrode exposed to one surface of the ceramic body. According to the present embodiment, the first internal electrode may be connected to an external polarity by the first and third external electrodes. In addition, the second external electrode 332 may be formed to be connected to the second lead-out portion 322a of the second internal electrode exposed to one surface of the ceramic body. The second external electrode 332 may be formed between the first and third external electrodes 331 and 333. In the present invention, the first and second electrodes may have different polarities, and the first and third electrodes may have the same polarity.

The first external electrode 331 may be connected to a portion of the first lead-out portion 321a that does not overlap the second lead-out portion 322a, and the third external electrode 333 maybe connected to a portion of the first lead-out portion 321b that does not overlap the second lead-out portion 322a. The second external electrode 332 may be connected to a portion of the second lead-out portion 322a that does not overlap the two first lead-out portions 321a and 321b.

In the right view of FIG. 10, overlapping areas between the two lead-out portions of the first internal electrode and the lead-out portion of the second internal electrode 322 are denoted by arrows, and the lead-out portion of the second internal electrode 322 that does not overlap the two lead-out portions of the first internal electrode is denoted by a dotted line.

According to the present embodiment, the insulation layers 341 and 342 may be formed on one surface of the ceramic body. The insulation layers 341 and 342 may be formed between the first and second external electrodes 331 and 332 and between the second and third external electrodes 332 and 333, respectively. When being formed to cover the first and second lead-out portions 321a, 321b and 322a exposed to one surface of the ceramic body, the insulation layers 341 and 342 may entirely cover the overlapping areas between the first and second lead-out portions.

The insulation layers 341 and 342 cover the lead-out portions 321a, 321b, and 322a of the first and second internal electrodes exposed to one surface of the ceramic body, whereby a short-circuit between the internal electrodes may be prevented and an internal defect such as deterioration in humidity resistance characteristics, or the like, may also be prevented.

According to the present embodiment, since even the lead-out portions of the first and second internal electrodes are ovelapped, capacitance of the multilayer ceramic capacitor may be increased. In addition, a distance between the first and second internal electrodes to which external polarities are applied may be relatively close, such that a current loop may be shortened. Therefore, ESL may be reduced.

Further, according to the present embodiment, current flows to the second internal electrode through the first internal electrode connected to the first and third external electrodes. Due to this current flow, a magnitude of an inductance component connected in series with a capacitance component of the multilayer ceramic capacitor may be significantly reduced.

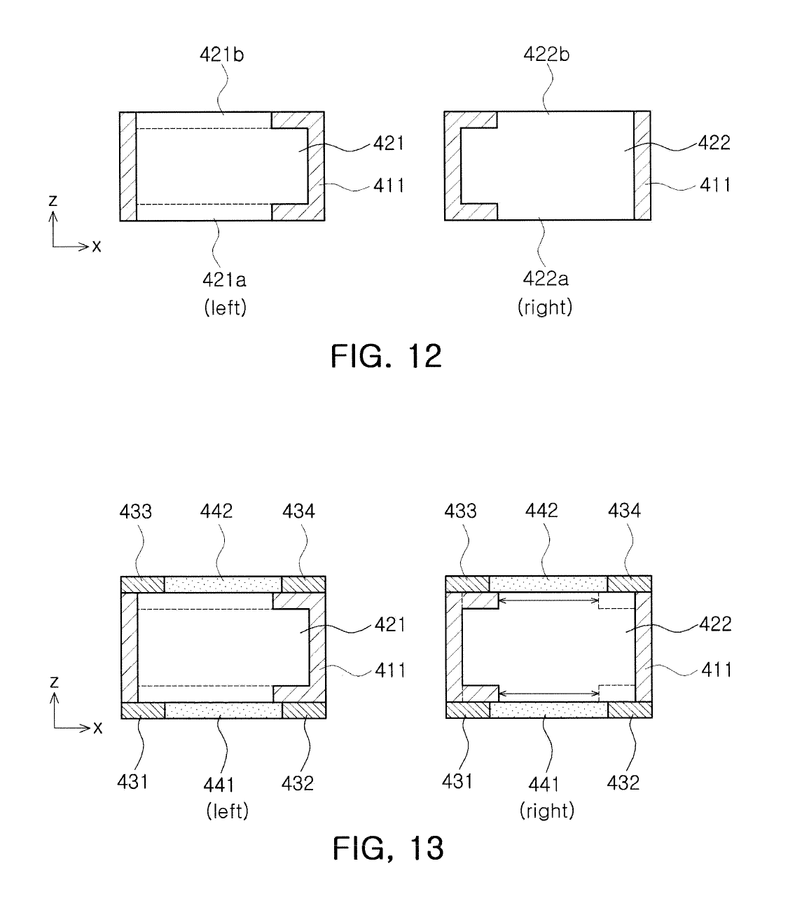

FIGS. 11 through 13 show a multilayer ceramic capacitor according to another embodiment of the present invention. FIG. 11 is a schematic perspective view showing the multilayer ceramic capacitor according to the present embodiment; FIG. 12 is a cross-sectional view showing a structure of internal electrodes of the multilayer ceramic capacitor shown in FIG. 11; and FIG. 13 is a cross-sectional view of the multilayer ceramic capacitor shown in FIG. 11. Hereinafter, components different from those of the above-mentioned embodiments may mainly be described and detailed descriptions of the same components will be omitted.

Referring to FIGS. 11 through 13, the multilayer ceramic capacitor according to the present embodiment may be a four-terminal vertically laminated or vertical multilayer capacitor. Here, “four-terminal” means that four terminals are connected to a circuit board as the capacitor terminals.

The multilayer ceramic capacitor according to the present embodiment may include a ceramic body 410; internal electrodes 421 and 422 formed within the ceramic body; and insulation layers 441 and 442 and external electrodes 431, 432, 433, and 434 formed on one surface of the ceramic body.

FIG. 12 is a cross-sectional view showing a dielectric layer 411 configuring the ceramic body 410 and the internal electrodes 421 and 422 formed on the dielectric layer. According to the embodiment of the present invention, the first internal electrode 421 having a first polarity and the second internal electrode 422 having a second polarity may be formed as a pair and be disposed to face each other in the y-direction, having the dielectric layer 411 interposed therebetween. According to the embodiment of the present invention, the first and second internal electrodes 421 and 422 may be disposed perpendicularly to a mounting surface of the multilayer ceramic capacitor.

According to the present embodiment, the mounting surface of the multilayer ceramic capacitor may be a first surface or a second surface opposing the first surface.

Referring to FIG. 12, the first and second internal electrodes 421 and 422 may have respective first and second lead-out portions 421a and 421b and first and second lead-out portions 422a and 422b so as to be connected to the external electrodes having different polarities. The two first lead-out portions 421a and 421b of the first internal electrode maybe exposed to the first surface of the ceramic body and the second surface thereof opposing the first surface, respectively, and the two second lead-out portions 422a and 422b of the second internal electrode may be exposed to the first surface of the ceramic body and the second surface thereof opposing the first surface, respectively.

In addition, the first lead-out portion 421a of the first internal electrode and the second lead-out portion 422a of the second internal electrode may be exposed to the first surface of the ceramic body and have an overlapping area. The first lead-out portion 421b of the first internal electrode and the second lead-out portion 422b of the second internal electrode may be exposed to the second surface of the ceramic body and have an overlapping area.

According to the embodiment of the present invention, the first lead-out portions 421a and 421b of the first internal electrode and the second lead-out portions 422a and 422b of the second internal electrode are exposed to the same surface of the ceramic body, and the exposed areas may be partially overlapped.

Referring to FIG. 13, the first and third external electrodes 431 and 433 may be formed on the first and second surfaces of the ceramic body so as to be connected to the lead-out portions 421a and 421b of the first internal electrode exposed to the first and second surfaces of the ceramic body, respectively. According to the present embodiment, the first internal electrode may be connected to an external polarity by the first and third external electrodes.

In addition, the second and fourth external electrodes 432 and 434 may be formed on the first and second surfaces of the ceramic body so as to be connected to the lead-out portions 422a and 422b of the second internal electrode exposed to the first and second surfaces of the ceramic body, respectively. According to the present embodiment, the second internal electrode maybe connected to an external polarity by the second and fourth external electrodes.

The first and second external electrodes 431 and 432 maybe formed on the first surface of the ceramic body, and the third and fourth external electrodes 433 and 434 may be formed on the second surface of the ceramic body. In the embodiments of the present invention, the first and second electrodes may have different polarities, the first and third electrodes may have the same polarity, and the second and fourth electrodes may have the same polarity.

The first external electrode 431 may be connected to a portion of the first lead-out portion 421a that does not overlap the second lead-out portion 422a, and the third external electrode 433 maybe connected to a portion of the first lead-out portion 421b that does not overlap the second lead-out portion 422b. The second external electrode 432 may be connected to a portion of the second lead-out portion 422a that does not overlap the first lead-out portion 421a, and the fourth external electrode 434 may be connected to a portion of the second lead-out portion 422b that does not overlap the first lead-out portion 421b.

In the right view of FIG. 13, overlapping areas between the two lead-out portions of the first internal electrode and the two lead-out portions of the second internal electrode 422 are denoted by arrows, and the lead-out portions of the second internal electrode 322 that do not overlap the lead-out portions of the first internal electrode are denoted by dotted lines.

According to the present embodiment, the insulation layers 441 and 442 may be formed between the first and second external electrodes 431 and 432 and between the third and fourth external electrodes 433 and 434, respectively. More specifically, the insulation layer 441 may be formed between the first and second external electrodes 431 and 432 on the first surface of the ceramic body and the insulation layer 442 may be formed between the third and fourth external electrodes 433 and 434 on the second surface of the ceramic body.

The insulation layers 441 and 442 may be formed to cover the first and second lead-out portions 421a, 421b, 422a, and 422b exposed to the surface of the ceramic body and entirely cover the overlapping areas between the first and second lead-out portions.

The insulation layers 441 and 442 cover the lead-out portions 421a, 421b, 422a, and 422b of the first and second internal electrodes exposed to the surface of the ceramic body, whereby a short-circuit between the internal electrodes may be prevented and an internal defect such as a deterioration in humidity resistance characteristics, or the like, may be prevented.

According to the present embodiment, since even the lead-out portions of the first and second internal electrodes are ovelapped, capacitance of the multilayer ceramic capacitor may be increased. In addition, a distance between the first and second internal electrodes to which external polarities are applied may be relatively close, such that a current loop may be shortened. Therefore, ESL may be reduced.

In addition, although not shown, the first or second internal electrode may include at least two lead-out portions. In addition, the first and second internal electrodes may include overlapping lead-out portions having different polarities. Further, the lead-out portions formed in the first and second internal electrodes may be exposed to the same surface of the ceramic body or may be exposed to different surfaces thereof. The number, positions, and the like, of the lead-out portions formed in the internal electrode may be variously adjusted by those skilled in the art.

As set forth above, according to the embodiments of the present invention, even the lead-out portions of the first and second internal electrodes are overapped, such that capacitance of the multilayer ceramic capacitor may be increased.

In addition, a distance between the first and second internal electrodes to which external polarities are applied may be relatively close, such that a current loop may be shortened. Therefore, equivalent series inductance (ESL) may be reduced.

According to the embodiments of the present invention, the insulation layer formed on the ceramic body covers the lead-out portions of the first and second internal electrodes exposed to one surface of the ceramic body, whereby a short-circuit between the internal electrodes may be prevented and an internal defect such as a deterioration in humidity resistance characteristics, or the like, may be prevented.

According to the embodiments of the present invention, the height of the insulation layer may be adjusted. When the height of the insulation layer is lower than those of the first and second external electrodes, the multilayer ceramic capacitor may be more stably mounted on the circuit board.

According to the embodiments of the present invention, the length of the multilayer ceramic capacitor in the x-direction is shorter than the length thereof in the y-direction, such that a distance between the first and second external electrodes maybe shortened and a distance between the first and second internal electrodes to which external polarities are applied may be relatively close. Therefore, a current loop may be shortened and ESL may be further reduced.

In the multilayer ceramic capacitor according to the embodiments of the present invention, current may flow to the internal electrodes through the plurality of external electrodes. Therefore, a magnitude of an inductance component connected in series with a capacitance component of the multilayer ceramic capacitor may be significantly reduced.

While the present invention has been shown and described in connection with the embodiments, it will be apparent to those skilled in the art that modifications and variations can be made without departing from the spirit and scope of the invention as defined by the appended claims.

What is claimed is:

1. A multilayer ceramic capacitor comprising:
a ceramic body;
first and second internal electrodes including respective lead-out portions having an overlapping area, the overlapping area being exposed to one surface of the ceramic body;
first and second external electrodes formed on the one surface of the ceramic body and connected to the respective lead-out portions; and
an insulation layer formed on the one surface of the ceramic body.

2. The multilayer ceramic capacitor of claim 1, wherein the lead-out portions of the first and second internal electrodes are exposed to the same surface of the ceramic body.

3. The multilayer ceramic capacitor of claim 1, wherein the first and second internal electrodes are disposed perpendicularly to a mounting surface of the ceramic body.

4. The multilayer ceramic capacitor of claim 1, wherein the first external electrode is connected to a portion of the lead-out portion of the first internal electrode that does not overlap the lead-out portion of the second internal electrode.

5. The multilayer ceramic capacitor of claim 1, wherein the insulation layer is formed by applying a ceramic slurry to the ceramic body.

6. The multilayer ceramic capacitor of claim 1, wherein the insulation layer entirely covers the overlapping area of the lead-out portions of the first and second internal electrodes.

7. The multilayer ceramic capacitor of claim 1, wherein the insulation layer has a height lower than those of the first and second external electrodes measured from the one surface of the ceramic body.

8. The multilayer ceramic capacitor of claim 1, wherein the ceramic body has a shorter length in an x-direction, in which the first and second external electrodes, having a predetermined interval therebetween, are formed, than that of a y-direction, in which the first and second internal electrodes are laminated.

9. The multilayer ceramic capacitor of claim 1, wherein the first internal electrode has at least two lead-out portions, and
the at least two lead-out portions of the first internal electrode form overlapping areas with the lead-out portion of the second internal electrode.

10. The multilayer ceramic capacitor of claim 1, wherein the first internal electrode has at least two lead-out portions exposed to the same surface of the ceramic body, and
the at least two lead-out portions of the first internal electrode form overlapping areas with the lead-out portion of the second internal electrode.

11. The multilayer ceramic capacitor of claim 1, further comprising a third external electrode connected to a respective lead-out portion of the first internal electrode,
wherein the first internal electrode has two lead-out portions, and
the two lead-out portions of the first internal electrode form overlapping areas with the lead-out portion of the second internal electrode.

12. The multilayer ceramic capacitor of claim 1, wherein the first and second internal electrodes have two respective lead-out portions exposed to the one surface of the ceramic body and the other surface opposed thereto, and
the two lead-out portions of the first internal electrode form overlapping areas with the two lead-out portions of the second internal electrode.

13. The multilayer ceramic capacitor of claim 1, further comprising third and fourth external electrodes connected to respective lead-out portions of the first and second internal electrodes,
wherein the first and second internal electrodes have two respective lead-out portions exposed to the one surface of the ceramic body and the other surface opposed thereto, and
the two lead-out portions of the first internal electrode form overlapping areas with the two lead-out portions of the second internal electrode.
